(19) United States
(12) Patent Application Publication
(10) Pub. No.: US 2010/0253069 A1
(43) Pub. Date: Oct. 7, 2010

(54) CONNECTION FITTING

(75) Inventors: Mario Bartholoma, Winden (DE); Fritz Zugel, Waldkirch (DE); Volker Gotz, Kenzingen (DE); Philipp Gerber, Gutach (DE)

Correspondence Address: VOLPE AND KOENIG, P.C., UNITED PLAZA, 30 SOUTH 17TH STREET, PHILADELPHIA, PA, 19103, US

(73) Assignee: HUMMEL AG, Denzlingen (DE)

(21) Appl. No.: 12/746,829

(22) PCT Filed: Aug. 5, 2008
(86) PCT No.: PCT/EP08/06414

§ 371 Date: Jun. 8, 2010

(30) Foreign Application Priority Data
Dec. 20, 2007 (DE) 202007017765.8

(51) Int. Cl. H02G 15/04

(52) U.S. Cl. 285/140.1

(57) ABSTRACT

A connection fitting (1) for cables (23), tubes or the like includes a tensioning element (6) which is inserted into the opening (2) in a wall (3) and latches thereto. A screw sleeve (5) which is connected to a lock (13) is screwed onto the tensioning element (6), wherein the lock (13) engages in the tensioning element (6) in the position of use and locks the latching. Fitting onto the screw sleeve (5) is a union nut (4) which is used to actuate clamping lamellae (25) which are formed on the screw sleeve (5) and clamp the cable (23) or the tube or the like. The screw threads are in the same direction, with the result that, when the union nut is screwed against the tensioning element, the screw sleeve is concomitantly moved and the screw sleeve (5) is screwed against the tensioning element. The lock (13) is arranged inside the screw sleeve (5) in one piece with the latter with a clearance, which has an annular cross-section, or an intermediate space (11) into which the region with the outer thread (12) of the locking element (9) fits.

### BACKGROUND

The invention relates to a connection fitting for fastening oblong objects, such as tubes, tubular shafts, pipes, cables, or the like, to an opening or a penetration or a hole, for example in a housing wall or the like, with the connection fitting comprising at least one fastening projection, which is divided via open slots into support latches, with holding protrusions being arranged at their free ends that project radially outward, with said support latches, when the fastening protrusions are inserted in the opening, penetration or a similar hole, being deformable radially inwardly by the edge of said hole and can reach the fastening position behind the edge, where the fastening protrusions at least partially engage under said edge, and with at least one stop being arranged at a distance from the fastening protrusions, which in the position of use contacts the undercut edge of the opening or a similar opposite edge of the hole and the connection fitting comprising at its interior a lock, allocated thereto and axially displaceable, which in the loosened position is arranged outside the area of the support latches or fastening protrusions and in the position of use arranged therebetween in an engaging fashion, and the fastening protrusions in the position of use blocking any radial deformation. The invention also relates to an angular or T-shaped connection fitting.

Such connection fittings are known from EP 1 065 426 B1, in which a lock comprises a profiled interior, which is accessible at both sides for an auxiliary tool shifting said lock between the loosened position and the fastening position.

From DE 198 12 079 C1 a connection fitting is known in which the support latches, at their area located inside an opening or the like in the position of use, show smaller exterior dimensions than the opening or the like and which can be expanded or spread via a lock displaceable therebetween in the axial direction.

A cable penetration device is known from DE 43 25 420 C2, in which a plug-in socket comprises at least two elastic snapping fingers and a clamping sheath, arranged inside the plug-in socket, is provided at one end with a clamping cage and at the other end with an expanded neck, with said snapping fingers being spread by the expanded neck.

### SUMMARY

The invention is based on the object of providing a connection fitting of the type mentioned at the outset, which can be assembled with little expense from its individual parts and which allows the fastening of cables, tubes, or similar oblong objects in an opening or hole of a wall with few operating steps.

In order to attain this object, the invention provides that the support latches are embodied on a tensioning element, that the tensioning element comprises a thread, that a screw sleeve is provided, with at one axial end thereof clamping lamellae or clamping fingers being formed to fasten the tubes or the like, that the lock is connected to said screw sleeve and is axially displaceable through the screw sleeve, that the screw sleeve comprises a first thread, matching the thread of the tensioning element, to axially displace the lock, that the screw sleeve shows an external thread for a union nut, serving to actuate the clamping lamellae or clamping fingers, and that the external thread of the screw sleeve is embodied in the same direction as the first thread of the tensioning element.

Due to the fact that the screw sleeve, on the one side, comprises clamping lamellae or clamping fingers and, on the other side, is connected to the lock the screw sleeve can act as one part having two functions, namely the fixation of a cable, tube, or a similar oblong object and the operation of the lock. This way, the number of components the connection fitting according to the invention is made of is reduced in reference to connection fittings of prior art. By the embodiment of matching threads at the tensioning elements and screw sleeves the operation of the lock can be performed by rotating the screw sleeve in reference to the tensioning element. By the embodiment of mutually matching threads at the screw sleeve and the union nut a fixation of the cable, tube, or the like can be achieved by actuating the clamping lamellae or clamping fingers, with the clamping lamellae or clamping fingers being actuated by a rotation of the union nut in reference to the screw sleeve.

This way, overall a rotation of the union nut in reference to the tensioning element can perform in a single operating step, on the one hand, an actuation of the clamping lamellae or clamping fingers and, on the other hand, an actuation of the lock, i.e. a transfer of the lock from the loosened position into the fastening position, thus in the axial area of the support latches by way of partially entraining the screw sleeves during the rotation of the union nut in reference to the tensioning element, thus rotating in the same direction, until the lock reaches the fastening position and here prevents any reverse rotation of the support latches radially inward. Expensive guidance means for the lock to prevent potential rotation can be omitted.

The lock that can be actuated by the screw sleeve can be inserted or plugged in as a sheath-like part of the screw sleeve, with a respective protrusion at the screw sleeve acting upon the lock for actuation. It is particularly beneficial and of considerably advantageous importance when the lock is connected to the screw sleeve in one piece. Thus, the lock and the screw sleeve can be produced from a single injection molded plastic part and requires no assembly for use or being brought into an assembled position.

One embodiment of the invention provides that the thread of the tensioning element is an external thread and that the first thread of the screw sleeve is an internal thread. This way, the tensioning element engages the interior of the screw sleeve and the side of the screw sleeve positioned radially outward in this axial engagement area offers an engagement surface for an actuating tool. This way, a short construction length of the connection fitting overall is achieved.

In an advantageous embodiment the first thread of the screw sleeve is arranged in a first axial area of the screw sleeve and the external thread of the screw sleeve in a second axial area of the screw sleeve, with the first axial area overlapping the second axial area of the screw sleeve. The first axial area therefore partially extends into the second axial area. Thus, in an overall axial length as short as possible, sufficient adjustment range is provided for the union nut and the tensioning element in reference to the screw sleeve and accordingly it is possible to fasten the connection fitting to walls having different wall thicknesses and tubes and the like having different tubular diameters.

The adjustment range of the union nut provided in reference to the screw sleeve determines the extent of actuation of the clamping lamellae or clamping fingers, thus the extension of their compression in order to fix a cable, a tube, or the like, while the adjustment range of the tensioning element provided in reference to the screw sleeve determines the range of wall thicknesses, for which the connection fitting is being embodied. By the ranges overlapping, i.e. an arrangement partially convoluted in the radial direction, the axial length is advantageously shortened even further.

It is particularly beneficial and useful for the screw sleeve to axially overlap the lock with an intermediate space having an annular cross-section. The sheath-like end of the tensioning element can be inserted into this intermediate space, and the connection between the lock and the screw sleeve and/or the actuation of the lock via the screw sleeve requires no expensive penetration of the lock through recesses of the tensioning element. The individual parts of the connection fitting can therefore be produced by way of simple injection molding technology and assembled with little expense. The intermediate space, formed by the screw sleeve overlapping and being annular in its cross-section, can advantageously be used to accept the first thread of the screw sleeve.

One embodiment of the invention may comprise that a stop is formed at the axial end of the screw sleeve, facing away from the clamping lamellae or clamping fingers. The stop forms a surface, which can contact the wall in the proximity of the opening or the like. The screw sleeve is axially displaceable via the first thread by way of rotation in reference to the tensioning element, with the distance between the stop, particularly the support surface formed by the stop, and the holding protrusions of the support latches being axially displaceable. This way, walls having different wall thicknesses can be accepted between the holding protrusions and the support surface of the stop, and via the stop and the holding protrusions a contact pressure can be applied upon the front and the back of the wall in the proximity of the opening or the like, by which the connection fitting can be fastened to the wall and secured against rotation.

In an advantageous embodiment, after being inserted in the position of use the tensioning element is held in the hole or the like in a form fitting and/or force fitting fashion. In particular, the support latches are embodied elastically and deflect radially inwardly when the tensioning element with the support latches is inserted through the opening or the like. When the connection fitting is inserted sufficiently deep into the opening, the holding protrusions reach behind the back of the wall forming the opening and relax radially outwardly, consequently holding the connection fitting to the wall in a form-fitting fashion.

It is particularly advantageous for the circumference, formed by the circularly arranged support latches, to be sized in reference to the opening such that the support latches cannot completely relax in the inserted state but apply a residual compression force upon the interior of the opening. This way, the connection fitting, particularly the tensioning element in the inserted or introduced state, i.e. in the position of use, is prevented from rotation in a force-fitting fashion. Here, it is advantageous that it is not required for the tensioning element to be held manually or by a tool when the screw sleeve or the union nut with the screw sleeve shall be screwed on. Rather, due to the friction caused by the not completely relaxed support latches, the tensioning element resists any entraining of the tensioning element by the screw sleeve to be screwed on or the union nut to be screwed on so that via the thread the screw sleeve is axially displaced in reference to the tensioning element, with the wall between the tensioning element and the screw sleeve, particularly a stop at the screw sleeve, being clamped. Alternatively or additionally, a form-fitting fastening may be provided in the circumferential direction of the hole or the like, by the support latches partially or in their entirety or other protrusions or recesses at the tensioning element engage corresponding formations at the edge of the hole in a form-fitting fashion.

In an advantageous embodiment the screw sleeve is provided with a flange, having a contact surface for a tool in order to be rotated, which in the position of use preferably contacts the side of the wall of the housing facing away from the fastening protrusions. Preferably the flange of the screw sleeve is formed with a hexagon and offers contact surfaces for a wrench or the like. Alternatively, the flange may also be formed as a tetragon or shows striations offering a better grip for manual operation. By the embodiment of a contact surface for a tool the fastening of the connection fitting at the wall after the screw connection was established can be secured from an unintentional loosening by way of further tightening. In one embodiment, a sealing ring is integrated in the contact surface of the flange, which deforms when the screw connection between the tensioning element and the screw sleeve is tightened and thus fixes the screw sleeve in reference to the wall.

It is particularly beneficial for the hexagon of the screw sleeve to have the same wrench size as the hexagon provided to actuate the union nut, because in this case a uniform tool can be used for tightening the screw connections of the connection fitting.

Additional advantageous embodiments result from combining the features of various claims or with features discernible from the description of the figures.

Primarily when one or more of the above-described features and measures are combined, a connection fitting results, in which the screw sleeve can be rotated when the fastening protrusion in its position of use is latched or snapped in, causing a compensation or adjustment to the thickness of the housing wall and automatically the lock is axially moved into the area of the support latches.

Here, it is primarily beneficial for the lock to be embodied in one piece with the screw sleeve, provided with clamping lamellae or clamping fingers, overlapping the lock with an intermediate space, annular in its cross-section, with the screw sleeve comprising an external thread for the union nut, serving to actuate the clamping lamellae or clamping fingers and an internal thread facing the intermediate space and limiting it towards the outside, for cooperating with and adjusting the lock, and for the external thread of the fastening protrusion to be able to be inserted into the intermediate space between the lock and the internal thread of the screw sleeve and matching said internal thread.

### BRIEF DESCRIPTION OF THE DRAWINGS

In the following, an exemplary embodiment of the invention is described in greater detail using the drawing. Shown in a partially schematic illustration are:

FIG. 1 a connection fitting in a partially exploded view,

FIG. 2 the connection fitting of FIG. 1 in a pre-assembled state, and

FIG. 3 a cross-section of the connection fitting of FIG. 1 in the position of use.

### DETAILED DESCRIPTION OF THE PREFERRED EMBODIMENT

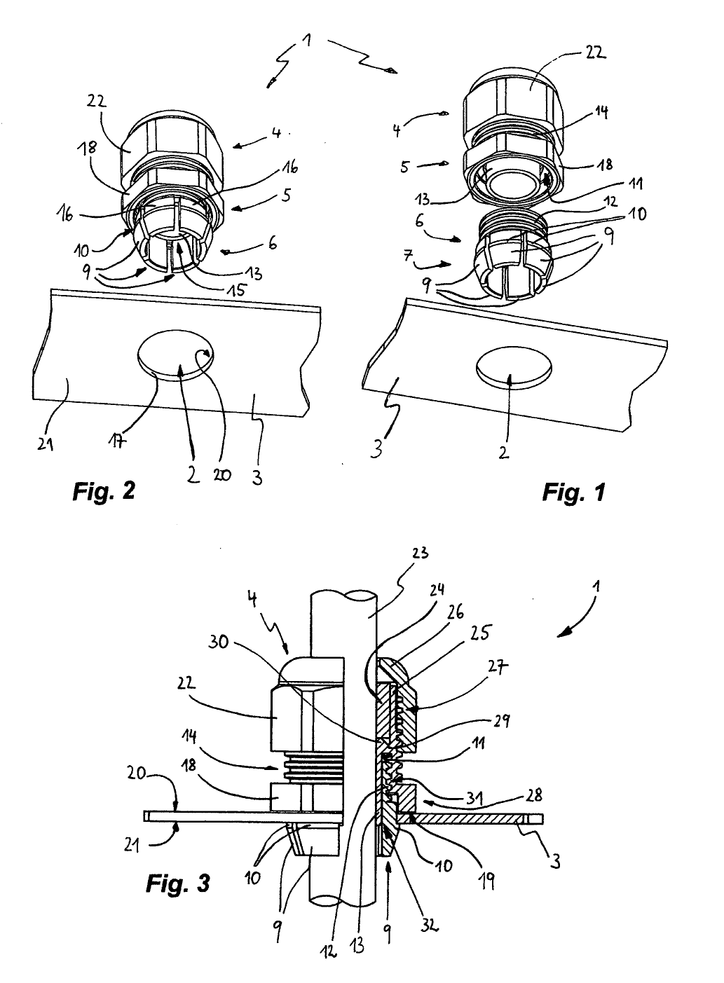

FIG. 1 shows a connection fitting, marked 1 in its entirety, to be assembled in an opening 2. The opening 2 is provided in a housing wall 3. Instead of a housing wall 3, a wall with an opening may also be used.

The connection fitting 1 is embodied in at least three parts and comprises a union nut 4, a screw sleeve 5, and a tensioning element 6. The end of the tensioning element 6 facing the housing wall 3 in FIG. 1 is embodied as a sheath-like fastening protrusion 7, which is divided by unilaterally open slots 8 into elastic support latches 9. The support latches 9 have fastening protrusions 10 facing outwardly, which in the position of use engage through the opening 2 engaging under the housing wall 3 and thus fasten the connection fitting 1 to the housing wall 3. To be operated, the tensioning element 6 is inserted into an annular intermediate space 11 of the screw sleeve 5, with an external thread 12 formed at the end of the tensioning element 6 opposite the support latches 9 fitting into a matching internal thread of the screw sleeve 5 and being screwed therein.

The screw sleeve 5 comprises a lock 13 embodied as a sheath, with its exterior diameter being smaller than the interior diameter of the tensioning element 6. This way, the lock 13 enters the annular intermediate space 11 in the area encompassed by the tensioning element 6 when the tensioning element 6 is inserted and screw-connected. The external diameter of the lock 13 is adjusted to the internal diameter of the tensioning element 6 such that the lock 13 contacts the interior surfaces of the support latches 9. Thus, when the tensioning element 6 has been screwed sufficiently far into the intermediate space 11 of the screw sleeve 5, the elasticity of the support latches 9 is reduced in the radial direction by the presence of the lock 13 and a deformation or reverse deformation of the support latches 9 into the loosened position is blocked.

Therefore, when the lock 13 is arranged in an area located adjacent to the axial area formed by the support latches 9 said support latches are elastic, thus allowing an insertion and removal of the tensioning element 6 into the opening and out of the opening, respectively. The lock 13 is therefore arranged in a loosened position. However, if the lock 13 is arranged in the axial area that is taken up by the support latches 9, thus when according to FIG. 3 the lock 13 is radially arranged over at least a portion of the axial extension inside the support latches 9 or therebetween, an elastic deflection of the support latches 9 is no longer possible and the tensioning element 6 can no longer be removed from the opening 2. Thus, in this position the lock 13 is in a fastened state of the connection fitting 1. The lock 13 is therefore transferred from a loosened position into a holding position by a shifting motion directed towards the housing wall 3.

The lock 13 is connected to a screw sleeve 5, causing the lock 13 to be axially displaced in reference to the tensioning element 6 when the external thread 12 of the tensioning element 6 is screwed into the internal thread in the intermediate space 11 of the screw sleeve 5.

The screw sleeve 5 is embodied as a socket and comprises an external thread 14 at its exterior, which is screwed into a matching internal thread of the union nut 4. The external thread 14 of the screw sleeve 5 and the external thread 12 of the tensioning element 6 are embodied in the same direction, resulting in both threads being tightened when the union nut 4 is rotated in reference to the tensioning element 6.

FIG. 2 shows the connection fitting 1 in the preassembled state, thus in the delivery state. In the preassembled state the screw sleeve 5 is partially screwed to the union nut 4 and the tensioning element 6 partially to the screw sleeve 5. For this purpose, particularly the tensioning element 6 is screwed into the screw sleeve 5 only to such an extent that the lock 13 cannot reach the axial area described by the slots 8 of the fastening protrusion 7, but maximally ends with the collar 15 connecting the support latches 9 of the tensioning element 6. Thus, in the delivery state, the elasticity of the support latches 9 radially inwardly is not compromised by the lock 13 and the tensioning element 6 can practically be inserted into the opening 2 without any resistance, latch in the position of use and can also be removed therefrom.

At the sides of the support latches 9 pointing radially outward, friction surfaces 16 are embodied each adjacent to the fastening protrusions 10. The friction surfaces extend over the support latches 9 from the collar 15, separating the external thread 12 and the support latches 9, to the connection of the fastening protrusions 10 and thus predetermine the maximum wall thickness of the housing wall 3 to which the connection fitting 1 can be mounted.

The friction surfaces 16 jointly describe a virtual cylinder, with its diameter in the relaxed state of the support latches 9 being slightly greater than the clear diameter of the opening 2. This way, the support latches 9 introduce a force to the interior edge 17 of the opening 2 via the friction surfaces 16, made to contact the interior edge 17 of the opening 2. Thus, the tensioning element 6 is fixed in the opening 2 in a force-fitting fashion and prevented from rotation in reference to the housing wall 3. This way, the screw sleeve 5 can be screwed to the tensioning element 6 when the tensioning element 6 is inserted in the opening 2 and the screw sleeve 5 is rotated in reference to the housing wall 3.

A hexagon 18 is embodied on the screw sleeve 5, comprising a contact surface for a tool, for example a wrench. The screw sleeve 5 is screw-connected to the tensioning element 6 to such an extent that the contact surface 19 embodied at the screw sleeve 5 contacts the front 20 of the housing wall and the holding protrusions 9 contact the back 21 of the housing wall 3, and thus the housing wall 3 is clamped between the tensioning element 6 and the screw sleeve 5. Thus, the hexagon 18 formed on the screw sleeve 5 forms a flange comprising a contact surface 19 serving as a stop for the screw sleeve 5. As explained in greater detail in the following with reference to FIG. 3, although the screw sleeve 5 can also be screwed in reference to the union nut 4, the screw sleeve 5 first resists said screw connection so that during actuation, i.e. screwing or rotating against the housing wall 3, the union nut 4 first entrains the screw sleeve 5, and thus the tensioning element 6 is screwed into the screw sleeve 5. However, when the housing wall 5 is clamped between the contact surface 19 and the fastening protrusion 10, the above-described resistance is overcome by actuating the union nut 4 and the screw-connection between the screw sleeve 5 and the union nut 4 is tightened, i.e. the screw sleeve 5 is further screwed into the union nut 4.

The union nut 4 initially also shows a hexagon 22, offering a contact surface for a tool. The hexagon 22 of the union nut 4 is embodied with identical dimension as the hexagon 18 of the screw sleeve 5. This way, on the one hand the same tool can be used for actuating the union nut 4 as well as the screw sleeve 5, on the other hand by contacting the operating tool oriented diagonally in reference to a radial direction the screw sleeve 5 and the union nut 4 can even be actuated simultaneously. In order to loosen the screw-connection, the hexagon 18 of the screw sleeve 5 is rotated, causing the tensioning element 6 clamped in the opening 2 to be screwed out of the screw sleeve 5, with the cable 23 remaining clamped.

FIG. 3 shows the connection fitting 1 of FIG. 1 in the position of use. A cable 23 is guided through the connection fitting 1 and fixed. The cable 23 is held in the screw sleeve 5 by a sealing ring 24, with said sealing ring 24 being pressurized by clamping lamellae 25 in the radial direction, with said pressure being introduced by the cooperation of the clamping lamellae 25 with the tapering 26 of the union nut.

An axial area of the screw sleeve 5, in which the external thread 14 is embodied at the exterior of the screw sleeve 5 is adjacent to the axial end section of the screw sleeve 5, in which the sealing ring 24 and the clamping lamellae 25 are arranged. The external thread 14 is screwed into a matching internal thread 27 of the union nut 4. By the screw-connection an axial displacement of the screw sleeve 5 is caused in reference to the union nut 4, pressing the clamping lamellae 25 against the tapering 26 and thus it is pressurized radially inwardly. Positioned at the other, opposite end of the screw sleeve 5 an axial area follows, which is adjacent to the axial area with the external thread 14, in which a flange 28 is embodied forming a hexagon 18 and representing the contact surface 19.

In the axial area of the external thread 14 of the screw sleeve 5 the lock 13 is connected to the screw sleeve 5 in one piece via a circular connection area 29. At the rear end of the screw sleeve 5, i.e. at the axial end pointing away from the housing wall 3, a protrusion 30 is formed, circumferentially extending around the cable 23 and radially undercut towards the outside, which axially entrains the sealing ring 24 with the clamping lamellae 25. The axial area of the screw sleeve 5, encompassing the external thread 14, and the flange 28 overlap the lock 13 in the axial direction, thus forming an approximately annular intermediate space 11 between the lock 13 and the screw sleeve 5. At the internal wall of the screw sleeve 5, in the area of said intermediate space 11, an internal thread 31 is formed, which is embodied matching the external thread 12 of the tensioning element 6. The tensioning element 6 is therefore screwed into the intermediate space 11. By this screwing motion the entrained lock 13 is axially displaced and contacts the interior sides of the support latches 9 and, with its frontal end section 32, presses radially outwardly against the support latches 9.

From FIG. 3 it is discernible that the sealing ring 24, compressed when the screw sleeve 5 is screwed to the union nut 4, provides a resistance against this rotation. In a screwing motion of the union nut 4 against the housing wall 3, which fixes the tensioning element 6 in a form-fitting fashion, as explained above, first the screw sleeve 5 is entrained until the contact surface 19 contacts the front 20 of the housing wall and the support latches 9, particularly the fastening protrusions 10, contact the rear 21 of the housing wall and the tensioning element 6 with the screw sleeve 5 apply pressure upon the housing wall 3. As soon as this compression is sufficiently strong, a resistance against the screwing process of the screw sleeve 5 towards the union nut 4 is overcome via the sealing ring 24, causing the clamping lamellae 25 to be actuated by the tapering 26 of union nut 4, i.e. pressed radially inwardly, and the sealing ring 24 is compressed by the clamping lamellae 25. Thus, by the compression of the sealing ring 24 a compression is introduced upon the cable 23 and the cable 23 is therefore held in the connection fitting in a force-fitting fashion. The sealing ring 24 not only causes a fixation of the cable 23 in the axial direction, but also seals the interior space adjacent to the rear 21 of the housing wall 21 from the exterior space adjacent to the front 20 of the housing wall 3 such that no liquids can seep along the cable 23 into the interior space. This sealing is achieved particularly such that the sealing ring 24 in case of a radial compression slightly deflects axially and thus presses against the protrusions 30.

An additional O-ring is inserted in the contact surface 19, which also seals the interior space from the exterior space, so that no liquids or dirt can enter between the internal thread 31 of the screw sleeve 5 and the external thread 12 of the tensioning element 6 and through the intermediate space 11 from the exterior space into the interior space enclosed by the housing wall 3.

A tensioning element 6 is allocated to the connection fitting 1 for cables 23, tubes, or the like, which is inserted into the opening 2 of a wall 3 and is snapped therein. A screw sleeve 5 is screwed upon the tensioning element 6, with the screw sleeve being connected to a lock 13, with the lock 13 in the position of use engaging the tensioning element 6 and fixing it in a latching manner. A union nut 4 fits onto the screw sleeve 5, by which the clamping lamellae 25 embodied on the screw sleeve 5 are actuated, holding the cable 23 or the tube or the like in a clamping fashion. The screw threads are embodied in the same direction, so that when rotating the union nut in reference to the tensioning element the screw sleeve is entrained, causing a rotation of the screw sleeve 5 in reference to the tensioning element. The lock 13 is preferably arranged, in one piece with the screw sleeve 5 in its interior space at a distance or intermediate space 11, having a circular cross-section, which can house the area with the external thread 12 of the lock 9.

1. A connection fitting for fastening oblong objects (23) to an opening (2) or a penetration or a hole, the connection fitting (1) comprising at least one fastening protrusion (7), which is divided by open slots (8) into support latches (9), with fastening protrusions (10) being arranged at free ends thereof, projecting radially outward, and the support latches (9) can be deformed radially inwardly when the fastening protrusion (7) is inserted into the opening (2), the penetration or hole past a hole edge and can enter an area behind the hole edge (17) in a holding position, in which the fastening protrusions (10) at least partially extend under said hole edge (17), and with at least one stop (19) being arranged at a distance from the fastening protrusions (10), which in a position of use contacts the edge of the opening (2) opposite the fastening protrusions (10) and the connection fitting (1) comprising in an interior an allocated lock (13), axially displaceable, which in a loosened position is arranged outside an area of the support latches (9) or the fastening protrusions (10) and in a position of use is arranged engaging them and the support latches (9) or the fastening protrusions (10), in the position of use, block any radial deformation, the support latches (9) are embodied at a tensioning element (6), the tensioning element (6) comprises a thread (12), screw sleeve (5) is provided, with clamping lamellae (25) or clamping fingers being formed at one of its axial ends for fastening the object (23) or the like, the lock (13) is connected to the screw sleeve (5) and can be axially displaced by the screw sleeve (5), the screw sleeve (5) has a first thread (31) matching the thread (12) of the tensioning element (6) for the axial displacement of the lock (13), the screw sleeve (5) has an external thread (14) for a union nut (4) serving to actuate the clamping lamellae (25) or clamping fingers, and the external thread (14) of the screw sleeve is embodied in a same direction as the first thread of the tensioning element (12).

2. A connection fitting according to claim 1, wherein the lock (13) is connected in one piece to the screw sleeve (5).

3. A connection fitting according to claim 1, wherein the thread (12) of the tensioning element (6) is an external thread and the first thread of the screw sleeve (5) is an internal thread (31)

4. A connection fitting according to claim 3, wherein the first thread (31) of the screw sleeve (5) is arranged in a first axial area of the screw sleeve (5), the external thread (12) of the screw sleeve (5) is arranged in a second axial area of the screw sleeve (5), and the first axial area overlaps the second axial area of the screw sleeve (5).

5. A connection fitting according to claim 3, wherein the screw sleeve (5) axially overlaps the lock (13) with an intermediate space (11), having an annular cross-section.

6. A connection fitting according to claim 5, wherein the first thread (31) of the screw sleeve (5) is arranged in the intermediate space (11), having the annular cross-section.

7. A connection fitting according to claim 1, wherein a stop (19, 28) is embodied at an axial end of the screw sleeve (5) facing away from the clamping lamellae (25) or the clamping fingers.

8. A connection fitting according to claim 1, wherein the tensioning element (6), after the insertion into the position of use, is held in at least one of a force-fitting or form-fitting fashion in the opening (2).

9. A connection fitting according to claim 8, wherein the force-fitting is caused by a pre-tension of the support latches (9), which in the position of use are pressed radially inwardly in reference to a relaxed state.

10. A connection fitting according to claim 1, wherein the screw sleeve (5) for rotating has a contact surface (18, 28) with a flange for a tool, which in the position of use contacts wall (3) of a housing at a side facing away from the fastening protrusions (10).

11. A connection fitting according to claim 10, wherein the flange (28) of the screw sleeve (5) is formed having a hexagon (18).

12. A connection fitting according to claim 11, wherein the hexagon (18) of the screw sleeve (5) has a same wrench width as a hexagon (22) provided to actuate the union nut (4).
